(19) United States
(12) Patent Application Publication
(10) Pub. No.: US 2009/0079217 A1
(43) Pub. Date: Mar. 26, 2009

(54) Powered Tailgate Ramp

(76) Inventors: Nikesh Bakshi, Granger, IN (US); Leonard D. Yoder, Elkhart, IN (US)

Correspondence Address: QUARLES & BRADY LLP, 411 E. WISCONSIN AVENUE, SUITE 2040, MILWAUKEE, WI, 53202-4497, US

(21) Appl. No.: 11/941,610

(22) Filed: Nov. 16, 2007

Related U.S. Application Data
(60) Provisional application No. 60/975,364, filed on Sep. 26, 2007.

(51) Int. Cl. B62D 33/03

(52) U.S. Cl. 296/61

(57) ABSTRACT

A tailgate ramp assembly for a vehicle is opened and closed by a linear actuator that engages an arm attached to the tailgate. The linear actuator is attached to a frame that includes guideways to guide a translatable member of the linear actuator. The translatable member of the linear actuator is pivotally connected to the arm of the tailgate through a linkage assembly.

### CROSS-REFERENCE TO RELATED APPLICATION

This application claims benefit to U.S. Provisional Patent Application No. 60/975,364, filed Sep. 26, 2007.

### STATEMENT CONCERNING FEDERALLY SPONSORED RESEARCH OR DEVELOPMENT

Not applicable.

### FIELD OF THE INVENTION

This invention relates to doors for vehicles, and in particular to tailgates of recreational vehicles (RVs), parcel delivery vehicles, and food/beverage delivery vehicles such that when opened serves as a ramp from the ground into the vehicle, for example for passage of an ATV, motorcycle, or automobile into and out of an RV or other commodities into and out of a delivery vehicle.

### BACKGROUND OF THE INVENTION

Recreational vehicles such as motor homes and trailers that have a rear opening door that also serves as a ramp require a substantial hinge mechanism to operate the door. Delivery vehicles may include similar doors. The door can be large, for example eight feet wide and seven to nine feet tall, and heavy, for example 350 lbs. or more. Most systems, both powered and manual, are counterbalanced with torsion springs wrapped around the door hinge. These torsion springs store energy when the door is lowered and assist in the raising of the door when it is closed. The assist provided by the springs allows the operator to manually lift the door if necessary.

Typical power systems for opening and closing such tailgates use a cable or cable and drum method for lifting the door. The cable is attached near the outer edge of the door and the power unit is mounted high inside the box of the vehicle. The exposed cable attached to the outer edge of the door when the door is lowered presents a tripping or other hazard if someone tries to enter or exit the vehicle from the side of the door.

Delivery vehicles sometimes incorporate lift mechanisms near a rear opening of the vehicle for loading and unloading commodities. However, such mechanisms require significantly more actuation than a ramp for loading and unloading the vehicle.

### SUMMARY OF THE INVENTION

The invention provides a tailgate ramp assembly for a vehicle that has a tailgate that also acts as a ramp when the tailgate is open. The tailgate is hinged to the vehicle chassis at a lower edge of the tailgate to pivot about a horizontal pivot axis. The hinge includes a hinge plate that is fixed to the tailgate and pivots about the pivot axis. The tailgate ramp assembly also includes a linear actuator with a base member mounted to a frame. The frame includes a guideway which guides a translatable member of the linear actuator. The translatable member is pivotally attached to an articulating arm which is also pivotally attached to an arm extending from the tailgate. Translating the translatable member in one direction opens the tailgate, and translating the translatable member in an opposite direction closes the tailgate.

In a preferred aspect of the invention, the frame includes a slot which permits rotation of the articulating arm.

In another preferred aspect of the invention, the frame is a tube attached to the vehicle chassis. The tube in a useful form encloses the base member of the linear actuator.

In yet another preferred aspect of the invention, the assembly includes a current sensor capable of detecting sudden current increases.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of the rear of a vehicle having a tailgate according to the present invention;

FIG. 2 is a detail perspective view of section 2-2 of FIG. 1;

FIG. 3 is a cross-sectional view from the plane of the line 3-3 of FIG. 4;

FIG. 4 is a cross-sectional view from the plane of the line 4-4 of FIG. 2;

FIG. 5 is a cross-sectional view similar to FIG. 4 with the tailgate moving through a position between open and closed positions;

FIG. 6 is a cross-sectional view similar to FIG. 4 with the tailgate in the closed position; and

FIG. 7 is a cross-sectional view of a second embodiment of the present invention.

### DETAILED DESCRIPTION OF THE PREFERRED EMBODIMENT

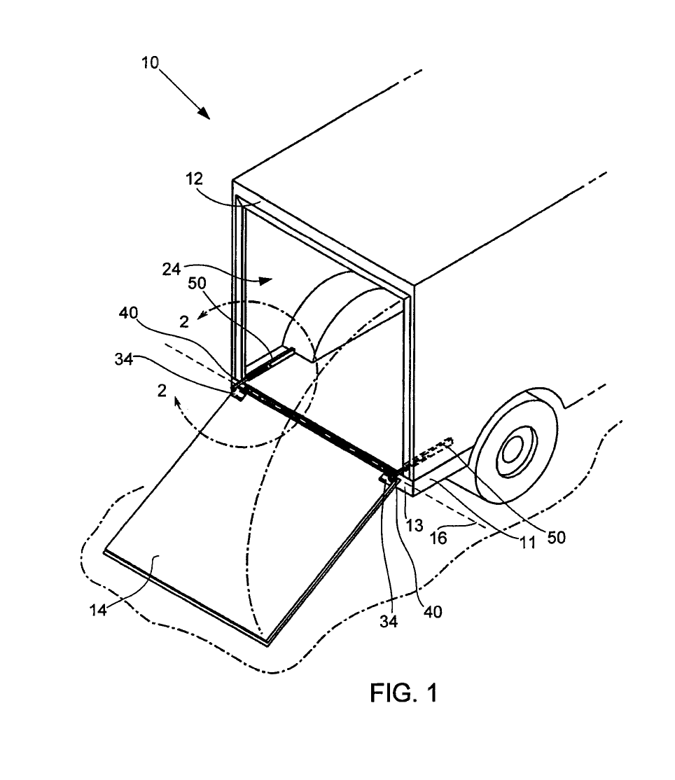

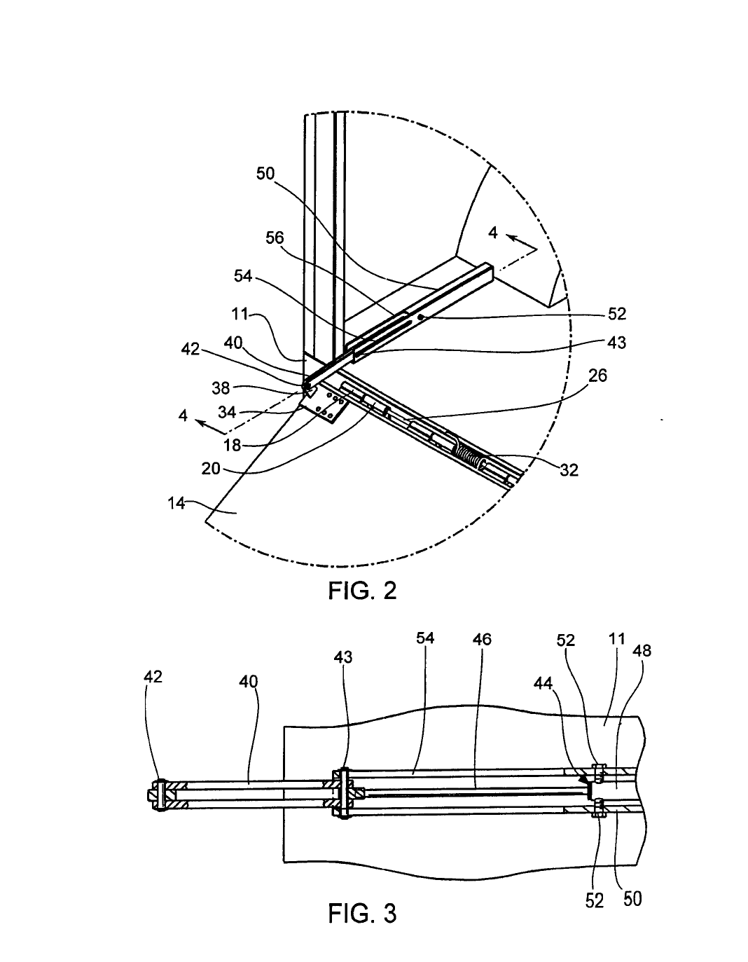

Referring to FIG. 1, a vehicle 10 which could be a trailer or a motor home, for example, has a rear end 12 that is closed or opened with a tailgate 14. The tailgate 14 is hinged at its lower edge to the vehicle 10 to pivot about axis 16. Referring to FIGS. 1 and 2, the tailgate 14 is connected to the vehicle 10 by upper hinge plates 18 and lower hinge plates 20 that alternate, with the upper hinge plates 18 fastened to the lower edge of the tailgate 14 and the lower hinge plates 20 fastened to a support rail 13 of chassis 11. The support rail 13 partially defines an opening 24 to a storage compartment of the vehicle. A hinge pin 26 (best seen in FIG. 2) connects the hinge plates 18 and 20 so that the hinge plates 18 are pivotable about axis 16 relative to the hinge plates 20.

The hinge plates 18 and 20 may be of a rolled construction or be of an extruded construction. In either case, each of the hinge plates 18 and 20 has a tubular portion 19 through which the hinge pin 26 extends and a generally flat or plate portion 21 which is secured to the respective tailgate 14 or support rail 13. The plate portions 21 of the upper hinge plates 18 are flat on the sides bolted against the tailgate 14 whereas the lower hinge plates 20 may be formed with a spacer section 28 that creates a space between the tubular portion of the hinge plates 18 and 20 and support rail 13 against which the plates 20 are fastened. Alternatively, the plates 20 could be the same as the plates 18 and provided with a separate spacer. Torsion springs 32 are preferably provided around the hinge pin 26 with one end pressing against one of the hinge plates 18 or against the tailgate 14 and the opposite end pressing against one of the plates 20 or against the support rail 13, so the space provided by the spacer section 28 also makes room for the springs 32. The torsion springs 32 bias the tailgate 14 into the closed position to make the tailgate 14 easier to lift when closing, for example, requiring less than 60 lbs. of force to lift the tailgate from the open position. Alternatively, other types of springs may be used to bias the tailgate 14 into the closed position. For example, extension springs may be connected between the tailgate 14 and the rear end 12 of the vehicle 10.

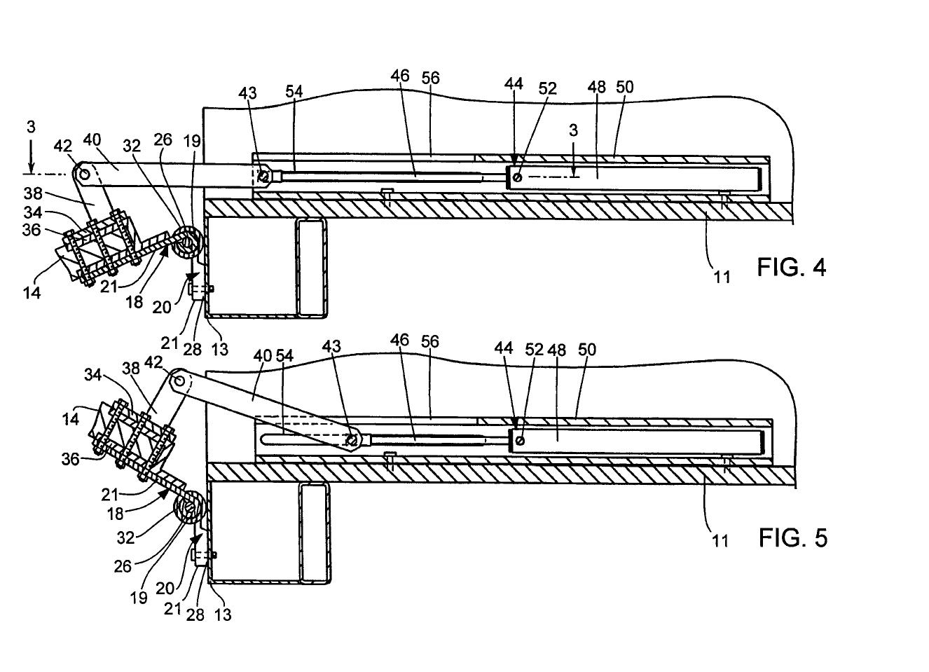

Referring again to FIG. 1, two plates 34 are located on the upper surface of the tailgate 14 when the tailgate 14 is in the open position. Plates 34 and components connected thereto are located near the sides of the vehicle 10. Plates 34 are commonly fastened to a frame 36 (as seen in FIGS. 4, 5 and 6) of the tailgate 14 and at least one upper hinge plate 18. Plates 34 comprise thin, rectangular pieces of material. As best seen in FIG. 2, plates 34 include arms 38 which extend perpendicularly away from the surface of the tailgate 14. Arms 38 comprise thin, short pieces of material. Plates 34 and arms 38 may be separate components which are welded together or single components made by well known manufacturing processes.

Each arm 38 is pivotally attached to a distal end of an articulating arm 40 by a pin 42. As shown in FIGS. 4, 5 and 6, articulating arm 40 extends generally frontward from the distal end to a proximal end. Articulating arm 40 is preferably comprised of thin material and includes two sections, as shown in FIG. 3. Alternatively, articulating arm 40 may be a single component with forked distal and proximal ends. In addition, the two sections of articulating arm 40 may be welded to each other or connected by a pin to provide additional strength. Referring again to FIGS. 4, 5 and 6, the proximal end of articulating arm 40 is pivotally connected to a translatable member 46 of a linear actuator 44 by a pin 43. Pin 43 is longer than pin 42 and moves in guideways 54 described in further detail below.

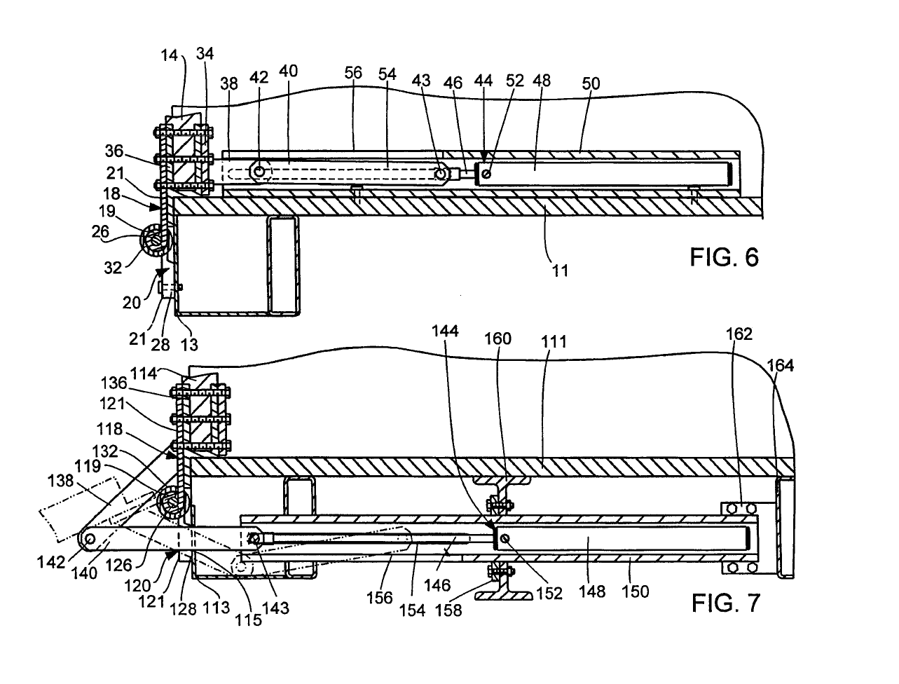

Translatable member 46 is slidably connected to a base member 48 of the linear actuator 44. Translatable member 46 moves generally in the direction of the longitudinal axis of the base member 48 and retracts inside the base member 48, as shown in FIG. 6. Base member 48 of the linear actuator 44 is fastened to a frame 50 by a pair of set screws 52 seated in a trunnion mount. The pair of set screws 52 should permit rotation of the base member 48. This is necessary since a small clearance is present between pin 42 and guideways 54. The linear actuator 44 would experience a bending load if the base member 48 was not permitted to rotate. Eliminating this bending load increases the service life of the linear actuator 44.

Frame 50 is also fastened to the chassis 11 and is located inside the storage compartment of the vehicle 10. Frame 50 is at least as long as the linear actuator 44 with the translatable member 46 fully extended and at least has a compartment large enough to accommodate the linear actuator 44. Accordingly, frame 50 may be formed from a square section of tube stock. Frame 50 also includes guideways 54 and a slot 56. Guideways 54 are located on the sides of frame 50 and permit motion of the pin 43 and the translatable member 46 generally in the direction of the longitudinal axis of base member 48. Slot 56 is located on the upper surface of frame 50 and permits rotation of articulating arm 40, as shown in FIG. 5.

When the tailgate 14 is open, as shown in FIG. 4, translatable member 46 is extended from base member 48 and articulating arm 40 is extended generally in the direction of the longitudinal axis of translatable member 46. The tailgate 14 is extended rearward and downward relative to the vehicle 10, permitting storage and removal of objects in the storage compartment of the vehicle 10. When moving the tailgate 14 to the closed position, as shown in FIG. 5, translatable member 46 moves generally in the direction of the longitudinal axis of base member 48 and retracts inside base member 48. Articulating arm 40 also rotates upward relative to the chassis 11 and the tailgate 14 rotates frontward towards the opening 24. When the tailgate 14 is closed, as shown in FIG. 6, translatable member 46 is retracted inside base member 48 and articulating arm 40 extends generally in the direction of the longitudinal axis of translatable member 46.

A second embodiment of the invention is shown in FIG. 7. Components similar to those of the first embodiment of the invention use identical numbers increased by 100. In this embodiment of the invention, the frame 150, the linear actuator 144, and the articulating arm 140 are located downward relative to the chassis 111 and outside the storage compartment of the vehicle. In addition, slot 156 is located on a lower surface of the frame 150. Arm 138 may be connected directly to at least one upper hinge plate 118 or may include a plate connected to at least one upper hinge plate 118. Alternatively, arm 138 may include a plate connected directly to the frame 136 of the tailgate 114. Also, articulating arm 140 passes through a slot 115 in the support rail 113 of the chassis 111.

The frame 150 includes a flange 158 which is fastened to a support beam 160 of the chassis 111. In addition, the frame 150 is connected to a U-bolt 162 which is connected to a support rail 164 of the chassis 111. U-bolt 162 may be connected to support rail 164 by welding, fasteners, or any other well known method. Fixing the frame 150 to the chassis 111 with these components reduces the amount of twist and bending stress experienced the frame 150 and the linear actuator 144, thus improving service life of the components. Alternatively, the frame 150 may be connected to the chassis 111 by fixing a spacer between the upper surface of the frame 150 and the lower surface of the chassis 111. Additionally, the frame 150 may be connected to the chassis 111 by any method which secures the frame 150 and prevents the frame 150 and linear actuator 144 from deforming.

For the second embodiment of the invention, when the tailgate 114 is closed, as shown in FIG. 7, translatable member 146 is extended from base member 148 and articulating arm 140 is extended generally in the direction of the longitudinal axis of the translatable member 146. When the tailgate 114 is open, as shown by the dash-dotted lines in FIG. 7, translatable member 146 is partially retracted inside base member 148 and articulating arm 140 extends downward and rearward from a proximal end to a distal end.

Motion of the linear actuators is preferably controlled by a toggle switch (not shown) which is movable to three positions: open, closed, and off. The toggle switch is preferably biased to the off position. That is, a user must hold the switch in the open or closed position to move the tailgate. If a user stops the tailgate in an intermediate position, the tailgate will slowly descend to the fully open position as hydraulic fluid is pushed out of the rod sides of the two actuators. An adjustable flow control valve can be included in the hydraulic circuit through which each rod side communicates with tank pressure so that the rate of descent can be controlled. If a screw drive is used rather than a hydraulic actuator, the ramp may stop in an intermediate position due to the resistance of the screw to turn, or the screw may turn slowly. The rate of turning may be controlled by using a variable speed motor or providing a brake or friction element in the drive train for the screw, that engages when power to the screw is turned off.

The linear actuators may be hydraulic actuators, electric screws, or ball screws. Such linear actuators are well known in the art. The dimensions and specifications of the linear actuators may be selected as appropriate for the size of the vehicle. If hydraulic actuators are used, a flow divider circuit may be used with a single pump to ensure the actuators move at uniform speed. Such a flow divider circuit is disclosed in FIG. 9 of U.S. Patent Application Publication No. 2006/0163859, the disclosure of which is hereby incorporated by reference. However, the flow divider circuit should not include pilot operated check valves (reference numeral 64 therein). This prevents the tailgate from remaining in a position other than the closed or open position. Also, it is also possible in some applications to not use a flow divider and just plumb the bi-direction hydraulic actuators in parallel, using a bi-directional pump, so that running the pump in one direction extends the actuators and running it in the other direction retracts them. The specifications of the hydraulic actuators may include a stroke of 10.75 in., a bore diameter of 1 in., and an operating pressure of 2000 psi. Such hydraulic actuators are capable of lifting a tailgate with an effective weight of 80 lbs. The term effective weight should be understood as the weight of the door that is not completely resisted by the torsion springs.

In addition, hydraulic actuators may be advantageous with the second embodiment of the invention since the translatable member extends as the tailgate is closed. Hydraulic actuators output more force during extension if the operating pressure is equal for extension and retraction. More force is required to move the tailgate to the closed position. Therefore, it is advantageous to close the tailgate while the translatable member extends.

If an electric screw or a ball screw is used, a manual crank may be included. The manual crank may be used to open and close the tailgate in the event of a power failure.

Several types of sensors may be used to control motion of the tailgate. Preferably, a current sensor is used to detect sudden current increases in the system. Such increases would occur if the tailgate has contacted the ground or the vehicle rear end when opening or closing, respectively. If the current exceeds a threshold value for a preset time period, the current sensor sends a signal to a controller to stop motion of the tailgate. For hydraulic actuators, pressure sensors could be used to detect sudden pressure increases in the system. Such increases would occur in the same manner as a current increase as described previously.

When opening the tailgate, motion will be driven by the weight of the door for much of the stroke, and the system may need a brake or controller to slow the opening motion. A speed sensor may be added to the system, and suitable electronic or mechanical controls may be provided to control opening speed. For example, a pulse width modulation controller may be used for motion control if a ball screw is used as the linear actuator. Alternatively, the system could be powered only in the closing direction, and manually opened without powering the linear actuators.

The vehicle may also include a latch for securing the tailgate in the closed position. The latch may be a manual latch or an automatic latch driven by a motor and controlled by a switch. Such an automatic latch is disclosed in U.S. Provisional Application 60894065, the disclosure of which is hereby incorporated by reference.

Several embodiments of the invention have been described in considerable detail. Many modifications and variations to the embodiments described will be apparent to a person of ordinary skill in the art. Therefore, the invention should not be limited to the embodiments described.

We claim:

1. In a tailgate ramp assembly for a vehicle that has a tailgate closeable over an opening into the vehicle with a hinge to the vehicle chassis at a lower edge of the opening to pivot about a pivot axis with the tailgate serving as a ramp from the ground into the vehicle through the opening when the tailgate is open, the improvement wherein:
the tailgate ramp assembly includes:
a frame, the frame having an actuator mounting portion and a guideway;
a linear actuator, the linear actuator having a base member attached to the actuator mounting portion of the frame and a translatable portion guided by the guideway of the frame;
an articulating arm having a proximal end and a distal end, the proximal end being pivotally attached to the translatable member to pivot about an axis that is generally parallel to the pivot axis of the tailgate of the vehicle, and the proximal end being guided to translate generally along a longitudinal axis of the translatable member by the guideway, so as to move with the translatable member guided by the guideway; and
an arm extending from the tailgate, the arm being pivotally attached to the distal end of the articulating arm, so the arm and the articulating arm pivot relative to one another about an axis that is generally parallel to the pivot axis of the tailgate to the vehicle, so that translating the translatable member relative to the base member of the linear actuator in a first direction opens the tailgate and translating the translatable member relative to the base member of the linear actuator in a second direction opposite the first direction closes the tailgate.

2. The tailgate ramp assembly of claim 1, wherein the frame is inside a storage compartment of the vehicle.

3. The tailgate ramp assembly of claim 1, wherein the frame is outside a storage compartment of the vehicle.

4. The tailgate ramp assembly of claim 1, wherein the arm connects to a plate which is fastened to at least one hinge.

5. The tailgate ramp assembly of claim 1, wherein the guideways are slots.

6. The tailgate ramp assembly of claim 1, wherein the frame has a surface defining a slot permitting rotation of the articulated arm.

7. The tailgate ramp assembly of claim 1, wherein the frame encloses the base member of the linear actuator.

8. The tailgate ramp assembly of claim 1, wherein the frame is attached to the vehicle chassis.

9. The tailgate ramp assembly of claim 1, wherein the frame is a tube.

10. The tailgate ramp assembly of claim 9, wherein the tube encloses the base member of the linear actuator.

11. The tailgate ramp assembly of claim 9, wherein the tube has a surface defining a slot permitting rotation of the articulated arm.

12. The tailgate ramp assembly of claim 1, wherein the linear actuator is a hydraulic actuator.

13. The tailgate ramp assembly of claim 12, wherein the hydraulic actuator is connected to a flow divider.

14. The tailgate ramp assembly of claim 12, wherein the assembly includes a pressure sensor capable of detecting sudden pressure increases.

15. The tailgate ramp assembly of claim 1, wherein the assembly includes a current sensor capable of detecting sudden current increases.

16. The tailgate ramp assembly of claim 1, wherein the linear actuator is an electric screw actuator.

17. The tailgate ramp assembly of claim 16, wherein the electric screw actuator includes a manual crank.

18. The tailgate ramp assembly of claim 1, wherein the linear actuator is a ball screw actuator.

19. The tailgate ramp assembly of claim 18, wherein the ball screw actuator includes a manual crank.

20. The tailgate ramp assembly of claim 1, wherein the assembly includes a toggle switch that controls motion of the tailgate.
